(19) United States
(12) Patent Application Publication
(10) Pub. No.: US 2010/0328691 A1
(43) Pub. Date: Dec. 30, 2010

(54) COMPUTER READABLE MEDIUM STORING A CONTROL PROGRAM FOR AN IMAGE PROCESSING DEVICE USING COLOR PROFILES, AND AN EVALUATION METHOD OF COLOR ADJUSTMENT RESULTS BY AN IMAGE PROCESSING DEVICE USING COLOR PROFILES

(76) Inventors: Toru HOSHINO, Tokyo (JP); Katsuji Kondo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/825,068

(22) Filed: Jun. 28, 2010

(30) Foreign Application Priority Data
Jun. 29, 2009 (JP) 2009-154156

(51) Int. Cl. H04N 1/60

(52) U.S. Cl. 358/1.9

(57) ABSTRACT

The control program of the present invention causes an image processing device to execute the steps of: executing a color conversion process on image data containing various color patches (S105); causing a printer to print the image data after the color conversion process and causing a color measuring device to measure the L*a*b* color values corresponding to the individual color patches contained in the output of the image data (S107); converting the CMYK color values corresponding to the individual color patches contained in the image data after the color conversion process into the L*a*b* color values by means of the input conversion table for the printer (S106); and calculating the differences between the L*a*b* color values measured by the color measuring device and the L*a*b* color values after the conversion based by means of the input conversion table for the printer (S108).

### CROSS-REFERENCE TO RELATED APPLICATION

This application is based on Japanese Patent Application No. 2009-154156, filed on Jun. 29, 2009, the contents of which are incorporated herein by reference.

### BACKGROUND

1. Technical Field

The present invention relates to a computer readable recording medium storing a control program of an image processing device using color profiles, and a evaluation method color adjustment results by an image processing device using color profiles.

2. Description of Related Art

Nowadays, many print shops are equipped not only with large-scale printing machines like an offset printing machine, but also with small-scale printing machines like a laser printer, which generally serve to proof larger scale printing machines, or to print a small amount of copies. However, commercial printing machines and general-purpose printers have different color reproducibility with each other due to the difference in their printing methods, and therefore their print outputs may have different colors even if they print the same image data. In this context, various techniques have been proposed for adjusting color profiles in order to match printed colors between devices.

Japanese Unexamined Publication No. 2004-153667 proposes an exemplary color proof system for adjusting printed colors by a low-end color printer to those by an large-scale printing machine (hereinafter called a target device). This system is provided with a color measuring device for measuring color patches within color charts printed by the color printer and the target device, respectively, and is designed to calculate correction values for correcting the color profiles, from the difference between the measured color values. This system is intended to lower the color difference below a certain level through repetitions of feed-back correction using the calculated correction values.

However, the aforementioned method including calculation of the difference in measured color values between the devices does not necessarily accomplish asymptotic approximation of the measure values for the printer into their target values (i.e. measured values for the target device) no matter how many times the correction is repeated. The is because color range of the color printer may be narrower than that of the target printer, and this narrower color range would causes inability of the color printer to reproduce some of the colors contained in a color chart, and thereby entailing color differences in these colors.

A similar problem may occur when the color printer and the target device use different types of printing paper from each other. Concretely speaking, while the color printer and the target device both reproduce the stark white color (C=M=Y=K=0%) by leaving blank the relevant portions of the paper surface, these blank portions may be erroneously recognized as different colors if these devices use different types of printing paper with different colors. In other words, the color measuring device may give a color difference even when there is no color adjustment error.

Thus, the system in the prior art will even attempt to correct the uncorrectable color difference if there is a mismatch between the reproducible color ranges by the devices or a difference between the types of printing paper used by the devices. This results in a difficulty in properly evaluating the color adjustment results, nor making corrections with a high accuracy.

The present invention is intended to solve the above-mentioned problem in the prior art, and its objective is to provide a control program of, and an evaluation method of color adjustment results by an image processing device capable of making the color adjustment of an object device to a target device through a color conversion process by means of color profiles, even in the presence of a mismatch between the reproducible color ranges of the devices or a difference between the types of printing medium used by the devices.

### SUMMARY

To achieve at least one of the above-mentioned objects, the computer readable recording medium reflecting one aspect of the present invention stores a control program of an image processing device capable of making color adjustment of an object device to a target device through a color conversion process which includes converting color values in a device-dependent color space in to those in a device-independent color space by means of an input conversion table of the color profile for said target device, and further converting the color values in said device-independent color space after the conversion into color values in said device-dependent color space by means of an output conversion table of the color profile for said object device.

Said program causes said image processing device to execute the steps of: (A) executing said color conversion process on image data containing various color patches; (B) causing said object device to output said image data after said color conversion process executed in said step (A), and causing a color measuring device to measure the color values in said device-independent color space corresponding to the individual color patches contained in the output of said image data; (C) calculating color values in said device-independent color space, defined as conversion-output values, by converting the color values in said device-dependent color space corresponding to the individual color patches contained in said image data after said color conversion process executed in said step (A) by means of said input conversion table for said object device; and (D) calculating the differences between the color values in said device-independent color space measured in said step (B) and the conversion-output values calculated in said step (C).

Preferably, the control program should further cause said image processing device to execute the step of (E) displaying information on the differences calculated in said step (D) on a display device.

Preferably, the program should further cause said image processing device to execute the steps of: (F) either calculating or causing said color measuring device to measure the color values in said device-independent color space, defined as target values, which correspond to the individual color patches contained in the output of said image data by said target device; and (G) calculating the differences between the target values calculated in said step (F) and the conversion-output values calculated in said step (C) as well as the differences between the target values calculated in said step (F) and the color values in said device-independent color space measured in said step (B).

Preferably, in said step (E), information on the differences calculated in said step (G) should be displayed, together with, or instead of information on the differences calculated in said step (D).

Preferably, the information should include at least one of the mean and maximum values of the difference for each of the color patches.

Preferably, the program should further cause said image processing device to execute the step of (H) of correcting said input conversion table for said target device based on the differences calculated in said step (D).

Preferably, in said step (H), said input conversion table for said target device should be corrected so that the color values in said device-independent color space after the conversion by means of said input conversion table will be replaced by the results of subtracting the differences calculated in said step (D) from the conversion-output values calculated in said step (C).

Preferably, said step (H) should be repeated more than one time.

Preferably, in the second round of said step (H) onward, said program should further cause said image program to execute the steps of: (I) causing said object device to output said image data after said color conversion process by means of said input conversion table for said target device after the most recent correction, and causing said color measuring device to measure the color values in said device-independent color space corresponding the individual color patches contained in the output of said image data by said target device; and (J) calculating the differences between the color values in said device-independent color space measured in said step (I) and the conversion-output values calculated in said step (C).

Preferably, said input conversion table for said target device should further be corrected so that the color values in said device-independent color space after the conversion by means of said input conversion table for said target device will be replaced by the results of subtracting the differences calculated in said procedure (J) from the color values in said device-independent color space after the conversion by means of said input conversion table after the most recent correction.

Preferably, said device-dependent color space is CMYK color space.

Preferably, said device-independent color space is L*a*b* color space.

The objects, features, and characteristics of this invention other than those set forth above will become apparent from the description given below with reference to preferred embodiments illustrated in the accompanying drawings.

### BRIEF DESCRIPTION OF THE DRAWINGS

FIG. 1 is a block diagram showing an exemplary structure of a color adjustment system according to an embodiment of the present invention.

FIG. 2 is a block diagram showing an exemplary structure of the printer shown in FIG. 1.

FIG. 3 is a block diagram showing an exemplary structure of the PC shown in FIG. 1.

FIG. 4 is a block diagram showing an exemplary structure of the color measuring device shown in FIG. 1.

FIG. 5 is a flowchart showing exemplary steps of the color adjustment of the printer executed by the PC according to an embodiment of the present invention.

FIG. 6 is a schematic view of an exemplary color chart used in an embodiment of the present invention.

FIG. 7 is a schematic view of an exemplary color profile for the target device according to an embodiment of the present invention.

FIG. 8 is an illustration to show how to generate color profiles according to an embodiment of the present invention.

FIG. 9 is an illustration to show exemplary steps of the color conversion process according to an embodiment of the present invention.

FIG. 10 is an illustration to show exemplary steps of the color conversion process according to an embodiment of the present invention.

FIG. 11 is an illustration to show how to calculate conversion-output values by the color conversion process according to an embodiment of the present invention.

FIG. 12 is an illustration to show how to calculate the color difference (ΔE) according to an embodiment of the present invention.

FIG. 13 is an illustration to show how to display the mean and maximum values of the color difference (ΔE) according to an embodiment of the present invention.

FIG. 14 is an illustration to show how to display the mean value and the maximum value of the color difference (ΔE) according to another embodiment of the present invention.

FIG. 15 is an illustration to show how to calculate the corrected conversion-output values according to an embodiment of the present invention.

FIG. 16 is an illustration to show how to calculate the corrected conversion-output values according to an embodiment of the present invention.

FIG. 17 is a conceptual diagram of the color conversion process by means of a corrected profile according to an embodiment of the present invention.

### DETAILED DESCRIPTION

The embodiments of this invention will be described below with reference to the accompanying drawings.

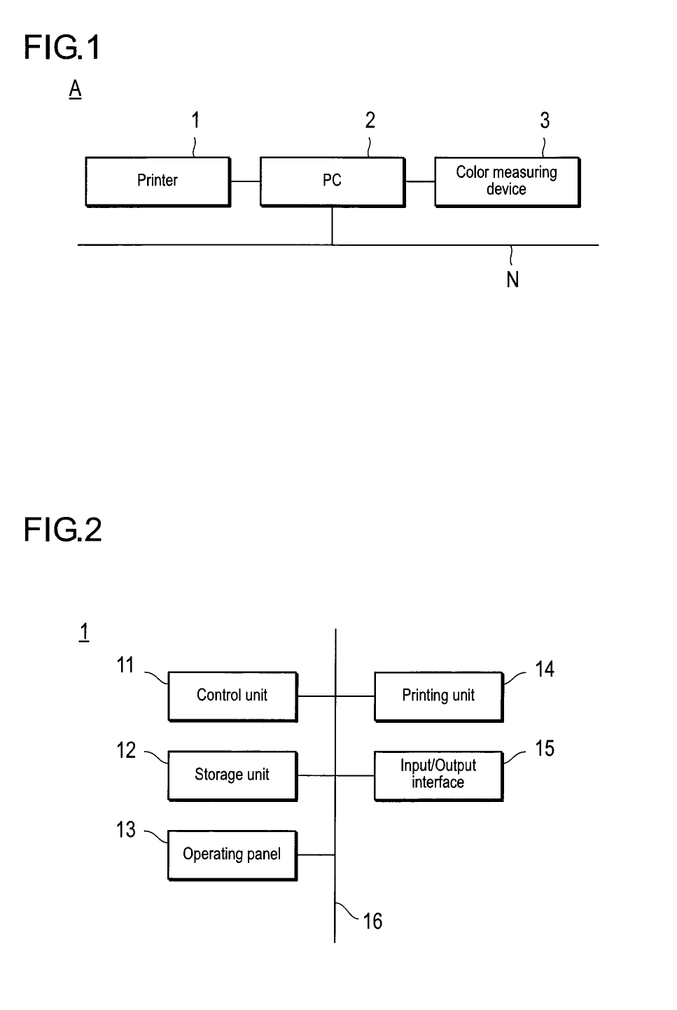

FIG. 1 is a block diagram showing an exemplary structure of a color adjustment system A, which includes an image processing device according to an embodiment of the present invention. The color adjustment system A is capable of making color adjustment of an image forming device (printer 1) to a target device such as a large-scale printing machine, or more specifically is capable of generating and correcting color profiles for a color conversion process on image data to be printed by the image forming device.

As shown in FIG. 1, the color adjustment system A is equipped with the printer 1, which is an object of the color adjustment, a PC 2 serving as the image processing device to perform various image processing on the image data to be printed by the printer 1, and a color measuring device 3 for measuring color values of the printed images by the printer 1. As shown in FIG. 1, the printer 1 is connected to the PC 2 via a printer cable complying with IEEE.1284, or a USB cable, the color measuring device 3 is connected to the PC 2 with a USB cable, and the PC 2 is connected to a network N like a LAN. The PC 2 can be a standalone device as shown in FIG. 1, or can be a built-in device of the printer 1. In the latter case, the printer 1 will be directly connected to the network N.

FIG. 2 is a block diagram showing an exemplary structure of the printer 1 in FIG. 1. As shown in FIG. 2, the printer 1 includes a control unit 11, a storage unit 12, an operating panel unit 13, a printing unit 14, and an input/output interface 15, all of which are interconnected via a bus 16 for exchanging signals.

The control unit 11 is a CPU for controlling various units according to control programs. The storage unit 12 contains a ROM for storing various programs, a RAM for temporarily storing various data to serve as a work area, and a hard disk for temporarily storing print data sent from the PC 2. The operating panel unit 13 is an operation panel with a touch panel capable not only of displaying various kinds of information but also of receiving user's instructions, and various fixed keys.

The printing unit 14 is an print engine for printing images based on the image data sent from the PC 2 on a recording medium, using the electronic photography method including the charging, exposing, developing, transferring, and fixing steps. The printing unit 14 can also use other printing methods such as the impact method, the thermal transfer method, the ink jet method, etc. The input/output interface 15 is an interface for communication with the PC 2, and is typically IEEE.1394 or USB. The printer 1 and the PC 2 can be connected via the network N as well, and in this case the input/output interface 15 can be an NIC (Network Interface Card) complying with standards as Ethernet®, Token ring, FDDI, etc.

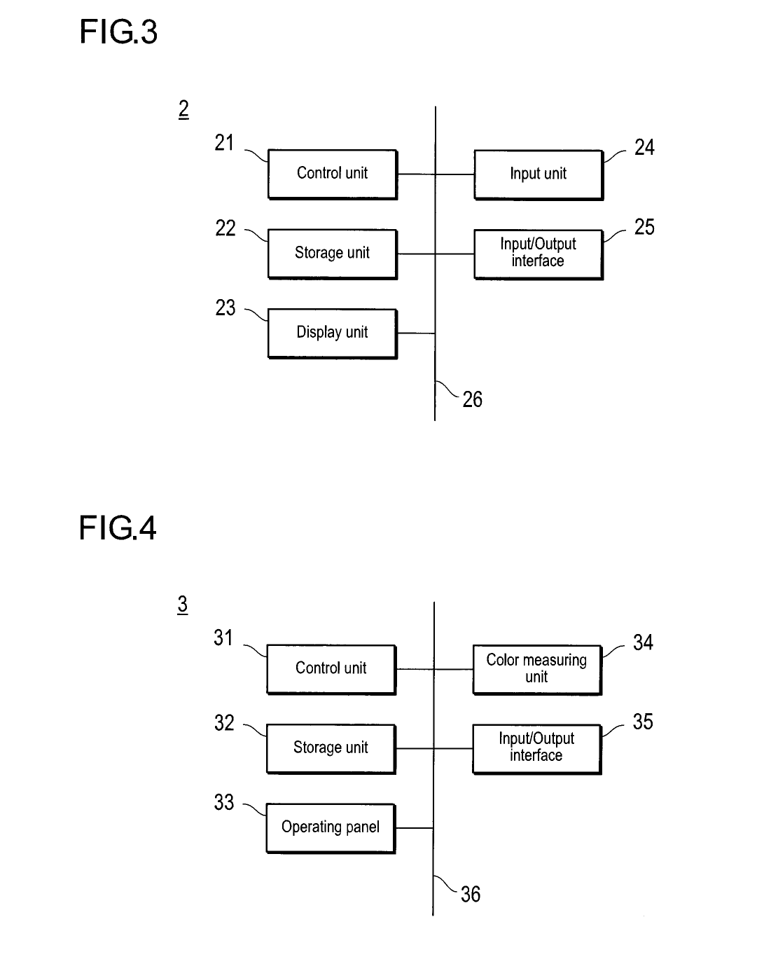

FIG. 3 is a block diagram showing an exemplary structure of the PC 2 in FIG. 1. As shown in FIG. 3, the PC 2 includes a control unit 21, a storage unit 22, a display unit 23, an input unit 24, and an input/output interface 25, all of which are interconnected via a bus 26 for exchanging signals. The PC 2 is designed to receive print data from other devices via the network N, perform various image processing on the received data including the RIP and the color conversion process, and then transfer the data after the image processing to the printer 1. This means that the PC 2 mainly serves as a printer controller of the printer 1 in the present embodiment.

The control unit 21 is a CPU for controlling various units and performing various calculations according to control programs. In particular, the control unit 11 in the present embodiment conducts the image processing on the print data sent from the outside. The storage unit 22 comprises a ROM for storing various programs and parameters for PC 2's basic operations, a RAM for temporarily storing various data to serve as a work area, and a hard disk for storing various programs including the OS. In particular, the hard disk of the storage unit 22 stores various programs for the image processing, together with color profiles used for the color conversion process.

The display unit 23 is a display device like a CRT display, a liquid crystal display, etc., and displays various kinds of information to user. The input unit 24 is a combination of a keyboard, a mouse, and other input devices, and is used by user to giving the PC 2 various instructions. The input/output network interface 25 is an interface for establishing connection with network devices on the network N, and is typically a NIC complying with standards like Ethernet®, Token Ring, FDDI, etc. The PC 2 is also designed to generate the color profiles used for the color conversion process, based on the data sent from the color measuring device 3. (See also FIG. 3.)

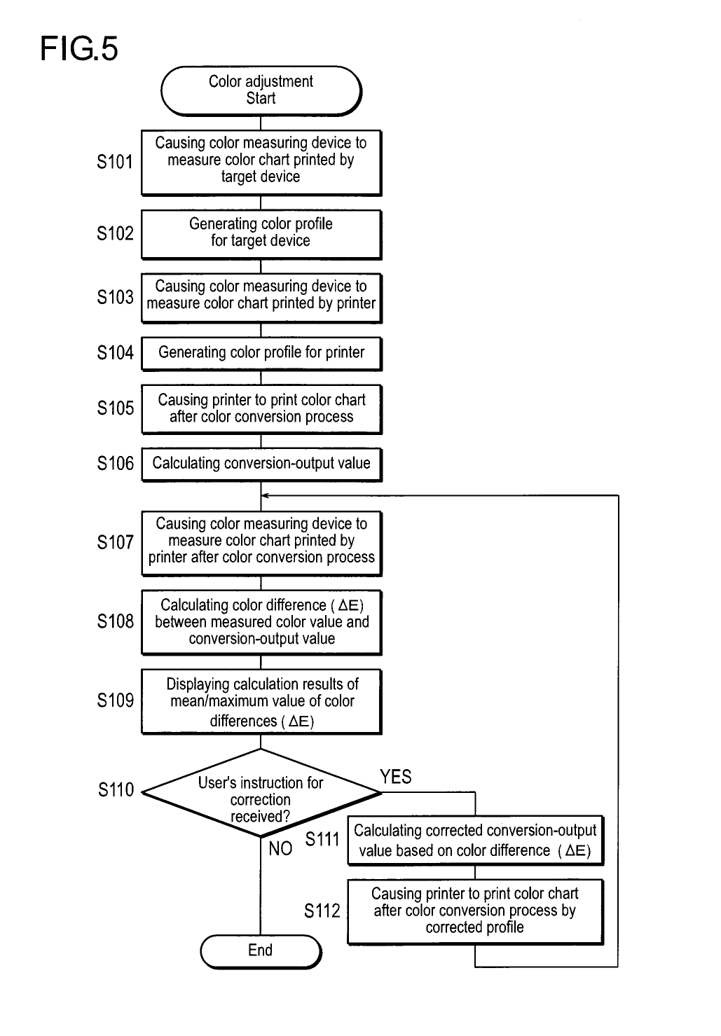

FIG. 4 is a block diagram showing an exemplary structure of the color measuring device 3 in FIG. 1. As shown in FIG. 4, the color measuring device 3 includes a control unit 31, a storage unit 32, a operating unit 33, a color measuring unit 34, and an input/output interface 35, all of which are interconnected via a bus 36 for exchanging signals. The color measuring device 3 is designed to make measurement of a color chart printed by a printing device like the printer 1, and convert the color measurement data into spectral reflectance values, XYZ color values, L*a*b* color values and other color values for each of the color patches contained in the color chart.

The control unit 31 performs various calculations in addition to controlling various units according to control programs. The storage unit 32 stores various programs and parameters. The storage unit 32 also retains temporarily the measurement data acquired by the color measuring unit 34. In particular, the storage unit 32 stores a program for converting the measurement data acquired by the color measuring unit 34 into L*a*b* color values. The operating panel unit 33 is a combination of fixed keys for receiving user's instructions.

The color measuring unit 34 makes measurement of each color patch by moving a spectrophotometer over a color chart, and transmits the measurement results to the storage unit 32. The color measurement results will be converted into spectral reflectance values, XYZ color values, or L*a*b* color values after being received by the storage unit 32.

The following is an outline of the operation by the color measuring system A in the present embodiment. FIG. 5 is a flowchart showing exemplary steps of the color adjustment of the printer 1 executed by the PC 2 according to the embodiment of the present invention. The color adjustment is intended to make color adjustment of the printer 1 to the target device through the color conversion process by means of color profiles. The algorithm shown in FIG. 5 is stored as a control program in the ROM in the storage unit 22, and is read out to be executed by the control unit 21 when the operation starts.

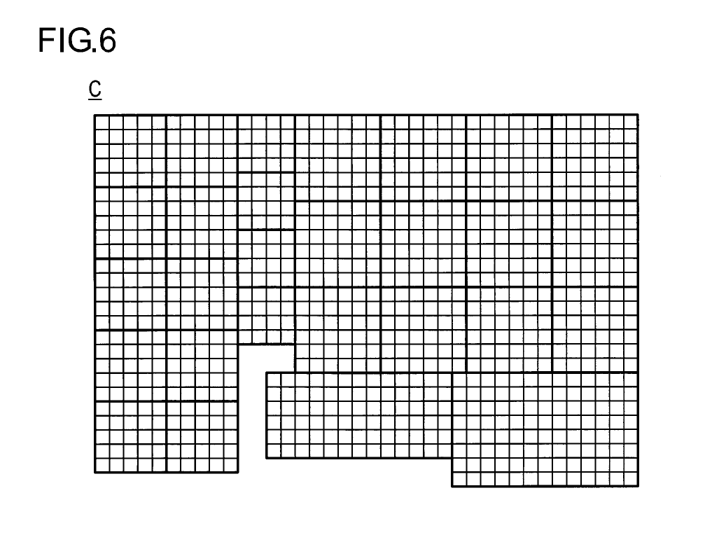

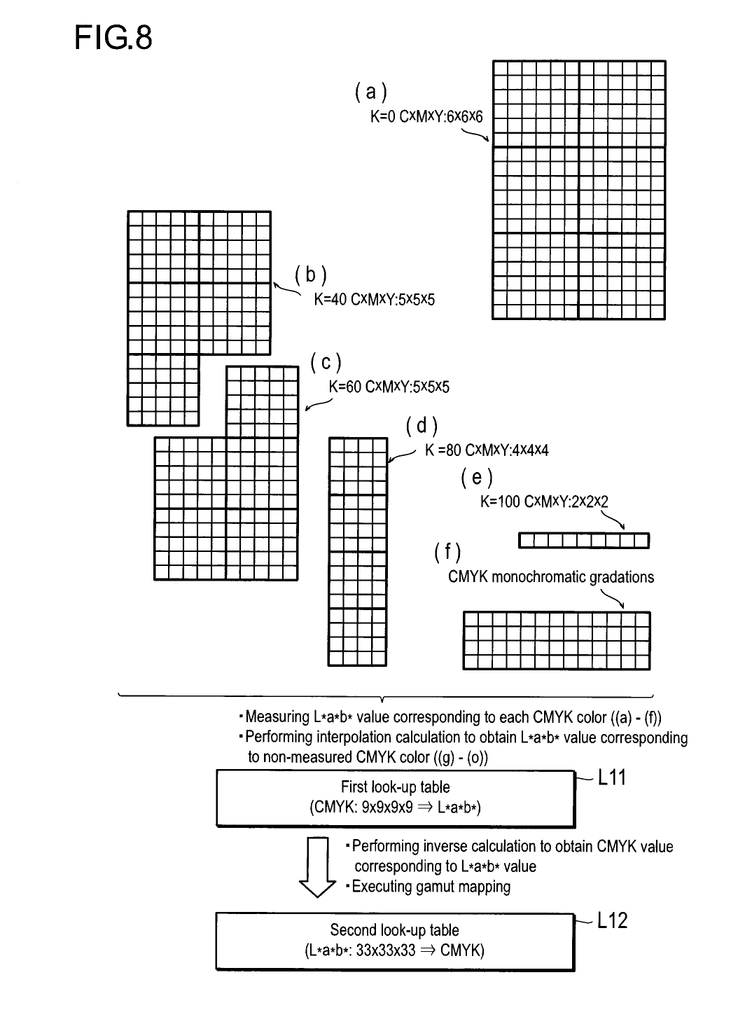

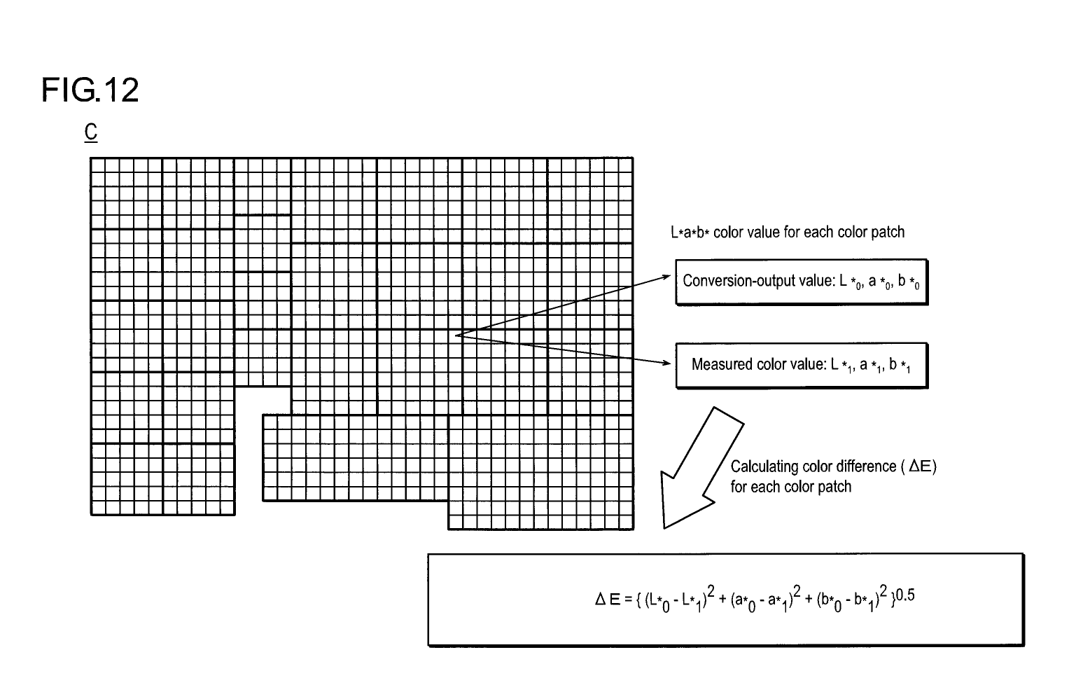

Firstly, the PC 2 causes the color measuring device 3 to make measurement of the color chart printed by the target device in order to acquire L*a*b* color values for individual color patches contained in the color chart (S101). The PC 2 generates the color profile for the target device based on the L*a*b* color values acquired in S101 (S102), and stores the color profile into the storing unit 22. The color chart in the present embodiment is a color chart complying with ISO 12642. FIG. 6 is a schematic view of the color chart C in the present embodiment. (Colors in the chart are omitted for simplification. The same in FIG. 8 and FIG. 12.)

Next, the PC 2 causes the printer 1 to print the color chart without executing the color conversion process, and then causes the color measuring device 3 to measure the image printed by the printer 1 in order to acquire L*a*b* color values for individual color patches (S103). The PC 2 then generates the color profile for the printer 1 based on the L*a*b* color values acquired in S103 (S104), and stores the color profile into the storing unit 22.

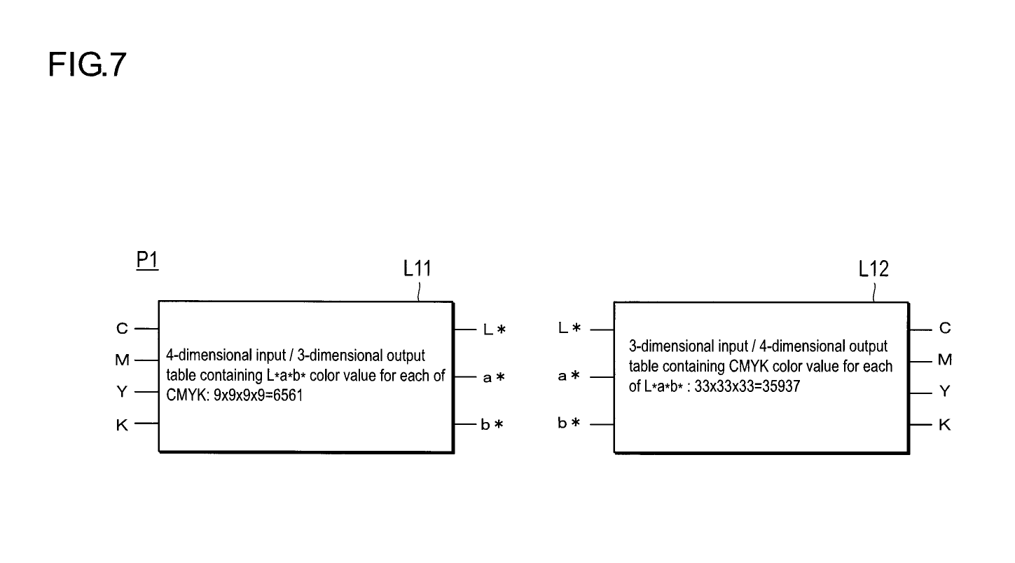

FIG. 7 is a conceptual diagram of the color profile P1 for the target device generated in S102. As shown in FIG. 7, the color profile P1 is a pair of look-up tables (first and second look-up tables L11 and L12). The first look-up table L11 is a conversion table for converting CMYK color values into L*a*b* color values, and contains L*a*b* color values corresponding to 6561 CMYK color values wherein the number of CMYK color values is derived from the multiplication of CMYK: 9×9×9×9 as shown in FIG. 7. The combination of 9×9×9×9 colors consist of 0%, 10%, 20%, 30%, 40%, 55%, 70%, 85%, and 100% for each of C, M, and Y, and 0%, 10%, 20%, 30%, 40%, 50%, 60%, 80%, and 100% for K wherein 100% is equivalent to the maximum value. These percentages (%) are chosen in consideration of conformity with the measurement points of the color chart as described later. Since none of the C, M, Y, K sample values have equal intervals between 0% and 100%, the color conversion by this table must be preceded by corrections of input CMYK values using a tone correction table so that each input value will conform to any of the 9 samples. The CMYK input values after the correction will be converted into L*a*b* values by such an interpolation method as described in the Japanese Unexamined Publication No. 2002-330303.

The second look-up table L12 is a conversion table for converting each L*a*b* color value into a CMYK color value, and it contains CMYK color values corresponding to 35973 L*a*b* color values wherein the number of L*a*b* color values is derived from the multiplication of L*a*b*: 33×33×33 as shown in FIG. 7.

A color profile P2 for the printer 1 is a combination of the first and second look-up tables L21 and L22, and is similarly generated in S104. The first look-up table is also called as input conversion table as this table is used at the input side of the color conversion, and the second look-up table is also called as output conversion table as this table is used at the output side of the color conversion. These synonyms for the tables will also be used in the following descriptions. In S102 and S104, the PC 2 can generate more than one type of different color profiles with different rendering intents like “colorimetric”, “perceptual”, “saturation”, etc.

The following is a detailed description of the generating method of the color profile P1 in S102 shown in FIG. 8. Firstly, the PC 2 in the present embodiment generates the first look-up table L11 in accordance with the steps (I) to (III) below:

(I) Causing the color measuring device to measure the L*a*b* color values corresponding to the following CMYK colors contained in the printed color chart:

(a) C×M×Y: 6×6×6 with K=0% (0%, 10%, 20%, 40%, 70%, and 100% for each of CMY)

(b) C×M×Y: 5×5×5 with K=40% (0%, 20%, 40%, 70%, and 100% for each of CMY)

(c) C×M×Y: 5×5×5 with K=60% (0%, 20%, 40%, 70%, and 100% for each of CMY)

(d) C×M×Y: 4×4×4 with K=80% (0%, 40%, 70%, and 100% for each of CMY)

(e) C×M×Y: 2×2×2 with K=100% (0% and 100% for each of CMY)

(f) Monochromatic gradations for each of CMYK (13 steps: 3%, 7%, 10%, 15%, 20%, 25%, 30%, 40%, 50%, 60%, 70%, 80%, and 90% for each color)

(II) Calculating L*a*b* color values corresponding to the CMYK colors shown in the paragraphs (g) to (k) using the measured L*a*b* color values in step (I) corresponding to the CMYK colors show in the paragraphs (a) to (e) above. Also calculating L*a*b* values for non-measured CMYK colors in the step (I), by means of an interpolation method based on the measurements for their adjacent colors as well as those for the monochromatic gradations shown in the paragraph (f) above.

(g) C×M×Y: 9×9×9 with K=0% (0%, 10%, 20%, 30%, 40%, 55%, 70%, 85%, and 100% for each of CMY)

(h) C×M×Y: 9×9×9 with K=40% (0%, 10%, 20%, 30%, 40%, 55%, 70%, 85%, and 100% for each of CMY)

(i) C×M×Y: 9×9×9 with K=60% (0%, 10%, 20%, 30%, 40%, 55%, 70%, 85%, and 100% for each of CMY)

(j) C×M×Y: 9×9×9 with K=80% (0%, 10%, 20%, 30%, 40%, 55%, 70%, 85%, and 100% for each of CMY)

(k) C×M×Y: 9×9×9 with K=100% (0%, 10%, 20%, 30%, 40%, 55%, 70%, 85%, and 100% for each of CMY)

(III) Calculating L*a*b* color values for the CMYK colors shown in the paragraphs (l) to (n) below, by means of an interpolation based on the L*a*b* color values obtained in the step (II) for the CMYK colors shown in the paragraphs (g) to (h) above and the L*a*b* color values obtained in the step (I) for the K monochromatic gradations shown in the paragraph (f) above, and further calculating L*a*b* color values for the CMYK colors shown in the paragraph (o) below by means of an interpolation based on the L*a*b* color values obtained in the step (II) for the CMYK colors shown in the paragraphs (h) to (i) above and the L*a*b* color values obtained in the step (I) for the K monochromatic gradations shown in the paragraph (f) above.

(l) C×M×Y: 9×9×9 with K=10% (0%, 10%, 20%, 30%, 40%, 55%, 70%, 85%, and 100% for each of CMY)

(m) C×M×Y: 9×9×9 with K=20% (0%, 10%, 20%, 30%, 40%, 55%, 70%, 85%, and 100% for each of CMY)

(n) C×M×Y: 9×9×9 with K=30% (0%, 10%, 20%, 30%, 40%, 55%, 70%, 85%, and 100% for each of CMY)

(o) C×M×Y: 9×9×9 with K=50% (0%, 10%, 20%, 30%, 40%, 55%, 70%, 85%, and 100% for each of CMY)

This is how the PC 2 in the present embodiment calculates a L*a*b* color value for each of C×M×Y×K: 9×9×9×9 in order to generate the first look-up table (input color conversion table) L11 for converting a CMYK color values into a L*a*b* color value.

The following is a description of the generating method of the second look-up table shown in FIG. 8. The PC 2 generates the second look-up table by means of an inverse calculation from the individual L*a*b* color values stored in the first look-up table L11. An exemplary method of the inverse calculation is disclosed in the Specification of Japanese Patent No. 2898030. Since reproducible color range (i.e. color range or color gamut) differs from one printing device to another, any L*a*b* color values outside the color gamut need to be replaced by other CMYK color values within the color gamut. The technique for replacing the color values is generally called “gamut mapping”. An exemplary gamut mapping method is disclosed in detail in the Specification of Japanese Unexamined Publication No. 2003-78773. The PC 2 in the present embodiment calculates CMYK color values for all of L*a*b*: 33×33×33 by means of gamut mapping if necessary.

As shown in FIG. 5, the PC 2 executes the color conversion process on the image data of the color chart C (hereinafter referred to as “image data” for simplification), using the color profiles P1 and P2 generated in S102 and S104, and then causes the printer 1 to print out the image data after executing the color conversion process on it (S105).

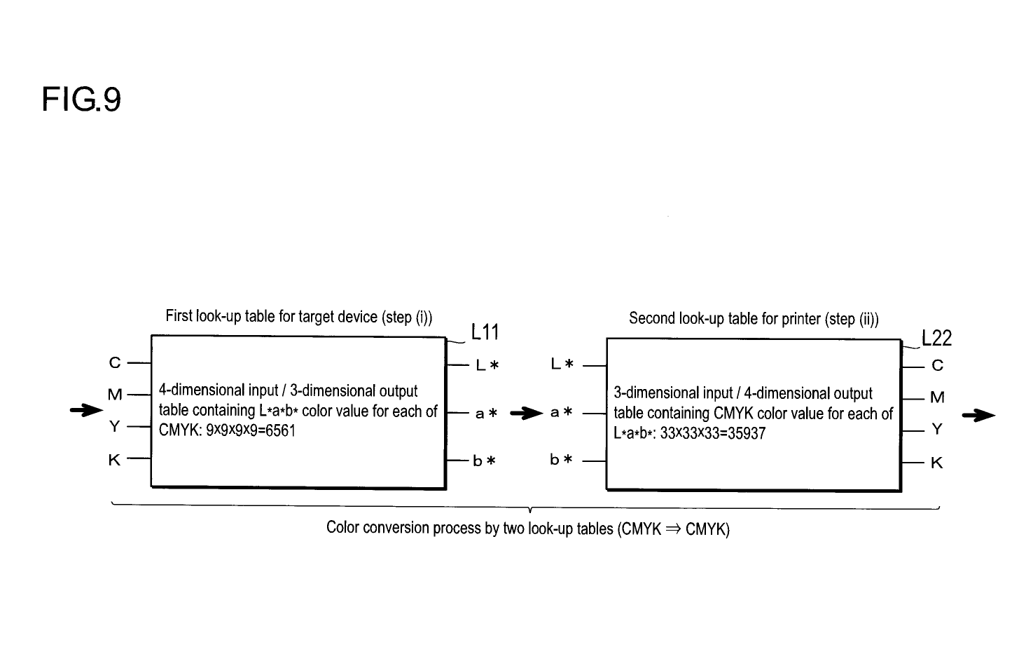

FIG. 9 shows exemplary steps of the color conversion process in S105. As shown in FIG. 9, the color conversion process on the image data includes the steps of: (i) converting each CMYK color value contained in the image data into a L*a*b* color value, using the first look-up table L11 (i.e. input color conversion table) generated in S102, and (ii) further converting the L*a*b* color values obtained in the step (i) into CMYK color values, using the second look-up table L22 (i.e. output color conversion table) generated in S104. There may be a difference in the L*a*b* value for C=M=Y=K=0% (stark white as background) between the profile for the printer 1 and that for the target device, due to a difference between paper types used by these devices. In such a case, each of the look-up tables should preferably be corrected to ensure correct conversion of C=M=Y=K=0%.

The method for this correction typically includes correcting the L*a*b* color values in such a way that the correction amount will decrease in proportion to the distance from the coordinate origin with C=M=Y=K=0%, or replacing the all L*a*b* color values with the media-relative L*a*b* color values which are calculated based on XYZ color values of stark white of each paper medium. In case of the media-relative L*a*b* values, C=M=Y=K=0% always becomes L*=100, a*=0 and b*=0 in each profile.

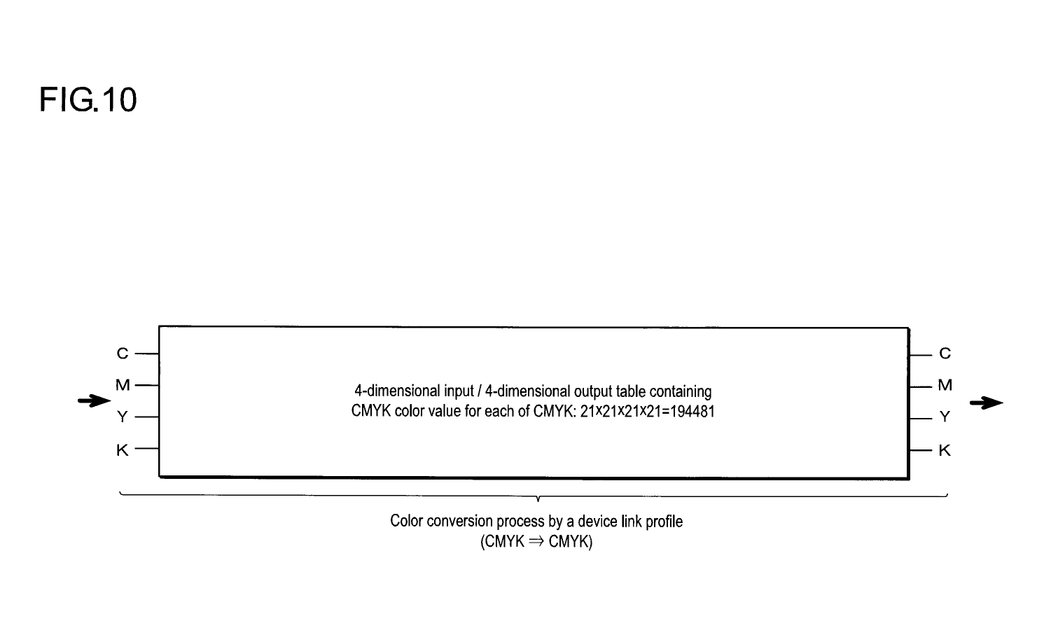

Instead of the two-step process illustrated in FIG. 9, the color conversion process can be a single-step process using a single look-up table generated by combining the two look-up table. This will allow for reduced time for completing the whole process. The single look-up table as mentioned above is generally referred to as “device link profile”. FIG. 10 shows an example of the color conversion process using a device link profile.

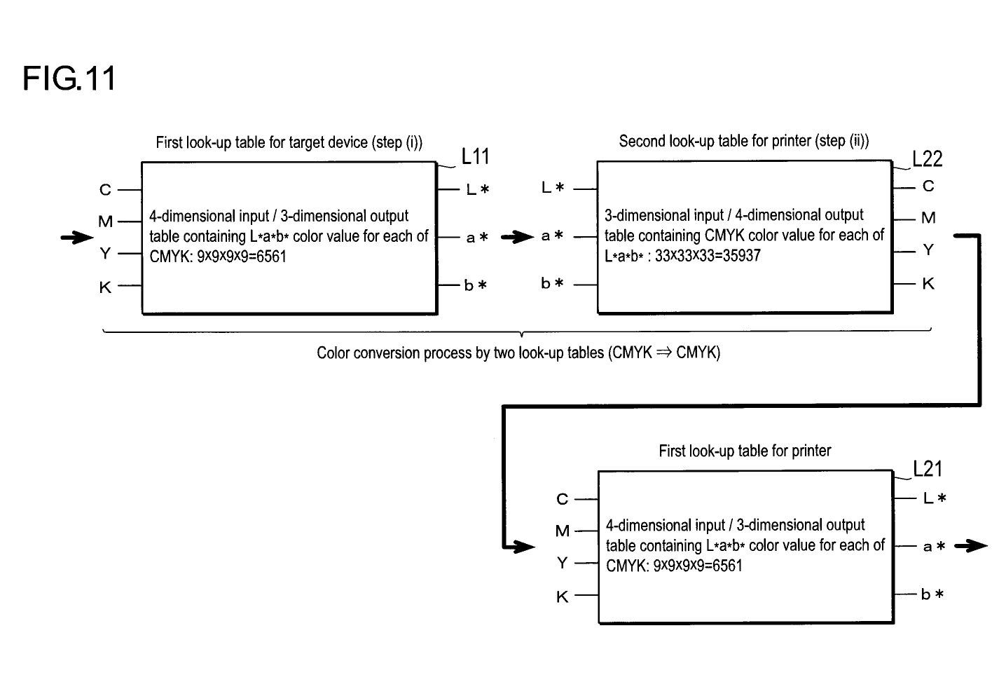

Next, the PC 2 calculates conversion-output values of the color conversion process in S105 (S106). A conversion-output value herein means a L*a*b* color value corresponding to each of the CMYK color values after the color conversion process in S105, and is calculated from the first look-up table for the printer 1. FIG. 11 is an illustration to show how to calculate the conversion-output values. As shown in FIG. 11, the conversion-output values are calculated by converting the individual CMYK color values after the color conversion process in S105 into L*a*b* color values, using the first look-up table (i.e. input color conversion table) L21 for the printer 1 generated in S104. The PC 2 calculates conversion-output values (L*a*b* color values) for all the color patches contained in the color chart (i.e. 590 colors consisting of C×M×Y: 6×6×6 with K=0%, C×M×Y: 5×5×5 with K=40%, C×M×Y: 5×5×5 with K=60%, C×M×Y: 4×4×4 with K=80%, C×M×Y: 2×2×2 with K=100%, and the monochromatic gradations for each of the CMYK (13-step gradations of 3, 7, 10, 15, 20, 25, 30, 40, 50, 60, 70, 80, 90)).

Next, the PC 2 causes the color measuring device 3 to measure an output of the color chart C printed by the printer 1 having executed the color conversion in S105, and acquires L*a*b* color values for the color patches (S107). The PC 2 then calculates the color difference ΔE between the measured color value in S107 and the conversion-output value calculated in S106 for each of the 590 color patches (S108).

FIG. 12 is an illustration to show how to calculate the color difference (ΔE). As shown in FIG. 12, the PC 2 calculates the color difference (ΔE) for each color patch by substituting the conversion-output value (hereinafter referred to as “L*₀, a*₀, b*₀”) calculated in S106 and the measured color value in S107 (hereinafter referred to as “L*₁, a*₁, b*₁”) into the mathematical formula (1) shown below. The color difference (ΔE) thus calculated is a theoretical value excluding the influence from the mismatch between the color gamuts reproduced by the target device and the printer 1 as well as the difference between the paper colors used by the target device and the printer 1. In other words, the color difference (ΔE) mainly indicates the level of color conversion errors during the color conversion process, which has to be taken into due consideration in evaluation of the color adjustment results.

ΔE={(L*₀−L*₁)²+(a*ₒ−a*₁)²+(b*₀−b*₁)²}^{0.5} Formula (1)

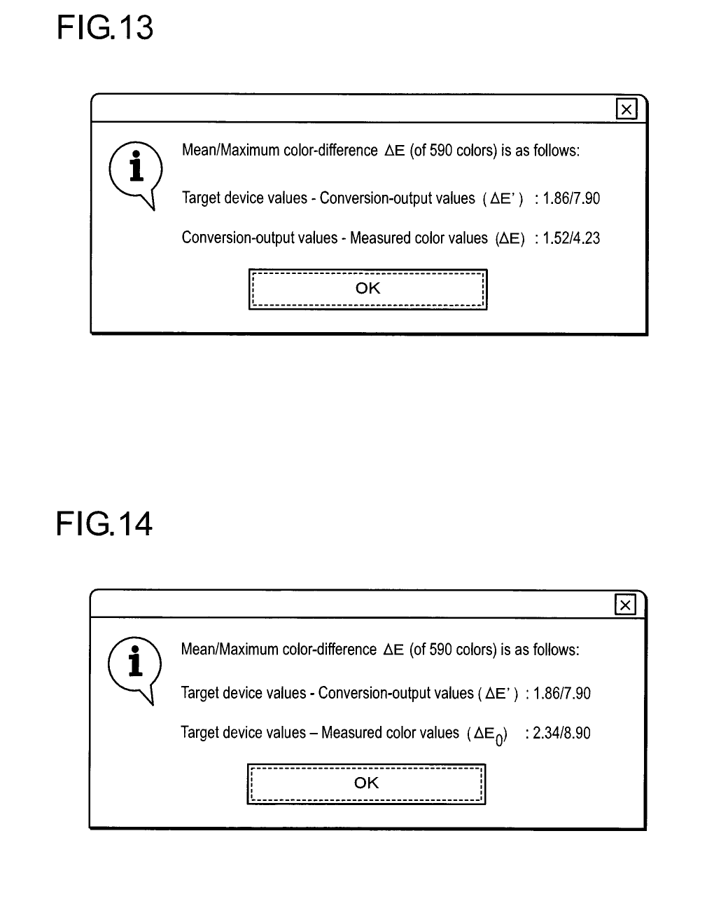

After calculating the color difference (ΔE) for each of the 590 color patches using the formula (1), the PC 2 further calculates the mean and maximum values of the color differences to display these values on the display unit 23 (S109). FIG. 13 is a schematic view of the display unit 23 displaying the calculation results in S109. In FIG. 13, the lower figures (i.e. 1.52/4.23) are the mean and maximum values of the color differences (ΔE) calculated in S108. These figures indicates the error level during the color conversion process as mentioned above, and therefore can be reduced to zero, theoretically speaking. In other words, accuracy of the color adjustment will be improved if the color profiles are corrected in pursuit of reducing these figures close to zero. The correction of color profiles will be shown below in detail. The upper figures (1.86/7.90) are the mean and maximum values of the color differences (ΔE′) between the measured color values of the color chart C printed by the target device and the conversion-output values, and they are displayed for a comparison purpose. The color differences (ΔE′) mainly indicate the mismatch between the color ranges of the devices as well as the difference the paper colors used by the devices.

FIG. 14 is another schematic view of the display unit 23 showing the calculation results in S109. In FIG. 14, the upper figures (1.86/7.90) are the mean and maximum values of the color differences (ΔE′) described above. The lower figures (2.30/8.90) are the mean and maximum values of the color differences (ΔE_{O}) between the measured color values of the color chart C printed by the target device and the measured color values of the color chart C printed by the printer 1. In other words, these color differences (ΔE_{O}) indicate the influence by the mismatch between the colors gamuts reproducible by the devices and the difference between the paper colors used by the devices as well as the color conversion errors. On the other hand, the upper figures mainly indicate the mismatch between the color gamuts and the difference between the paper colors as mentioned above, and therefore color adjustment accuracy will be improved by correcting the color profiles so that the lower figures will be reduced close to the upper figures.

The following is an observation on the color adjustment results of the colors outside printer 1's color gamut. As for 100% magenta (CMYK: 0/100/0/0), the measured color value (L*a*b* value) of the color chart C printed by the target device is 48.0/74.1/−8.1, the conversion-output value (L*a*b* value) is 46.4/66.5/−6.7, and the measured value (L*a*b* value) of the color chart printed by the printer 1 is 46.8/67.1/−7.9, which means that the color differences (ΔE_{O}) between the measured color values turn out to be relatively high: ΔE_{O}=7.1. On the other hand, the color differences (ΔE) between the conversion-output values and the measured color values turn out to be much smaller: ΔE=1.4. This suggests that comparisons between the conversion-output values calculated in the steps shown in FIG. 11, are more useful in properly evaluating reproducibility of the colors outside printer 1's color gamut, than those between the measured values by the two devices.

Observations on the color adjustment results of the stark white background (C=M=Y=K=0%) reveals that the measured value (in L*a*b*) of the color chart C printed by the target device is 94.0/0.7/−1.3, the conversion-output value (in L*a*b*) is 92.8/0.7/−0.2, and the measured value (in L*a*b*) of the color chart C printed by the printer 1 is 92.7/0.7/−0.5, meaning that the color difference (ΔE_{O}) between the measured values turns out to be 1.5 while the color difference (ΔE) between the conversion-output value and the measured value of the output printed by the printer 2 turns out to be no more than 0.2.

Observations on the adjustment results of the 10% cyan (CMYK: 10/0/0/0), which is similar in color to the stark white background, reveals that the measured value (in L*a*b*) of the color chart C printed by the target device is 90.7/−2.8/−5.5, the conversion-output target value (in L*a*b*) is 87.6/−2.3/−4.5, and the measured value (in L*a*b*) of the color chart C printed by the printer 1 is 88.8/−3.0/−3.7. This means that the color difference (ΔE) between the conversion-output value and the measured value of the output turns out to be no more than 1.6 while the color difference (ΔE_{O}) between the measured values turns out to be 2.5. This suggests that a comparison between the conversion-output value as shown in FIG. 11 and the measured value of the output by the target device is more useful for properly evaluating the reproducibility of the colors similar to the stark white like the 10% cyan, rather than those between the measured values, as these colors are susceptible to the influence by the difference between paper colors for printing.

As shown in FIG. 5, the PC 2 acquires from user having checked the calculation results as shown in FIG. 13 or 14, an instruction on whether or not it should correct the color profiles P1 and P2 (S110). The PC 2 will terminate the series of steps if it receives an instruction not to correct the color profiles (S110: No), while proceeding to S111 described below if it receives an instruction to correct the color profiles (S110: Yes).

In the latter case, the PC 2 corrects the first look-up table (i.e. input color conversion table) L11 for the target device based on the color differences (ΔE) calculated in S108. More specifically, the PC 2 calculates corrected values (hereinafter called as “corrected conversion-output values”) for the conversion-output values calculated in S106, based on the color differences (ΔE) calculated in S108 (S111), and replaces the L*a*b* color values contained in the first look-up table L11 by these corrected conversion-output values.

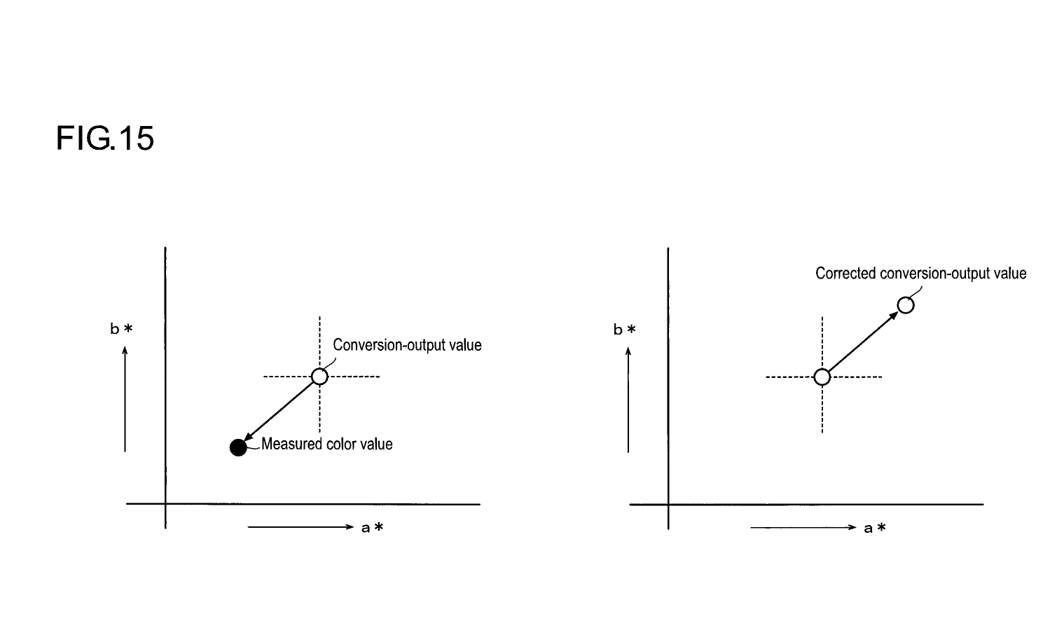

FIG. 15 is an illustration to show how to calculate the corrected conversion-output values. The left-side diagram in FIG. 15 shows a relationship between the conversion-output value and the measured color value of a certain color patch, and the right-side diagram shows a relationship between the conversion-output value in the left-side diagram and the corrected conversion-output value. As shown in these diagrams, the corrected conversion-output value should be located at the position coordinate which is apart from the original conversion-output value by the distance equal to the color difference (ΔE) to the measured color value in the opposite direction. Such substitution of the corrected conversion-output value for the original conversion-output value will allow for a reduction of the color difference (ΔE) after the color conversion process.

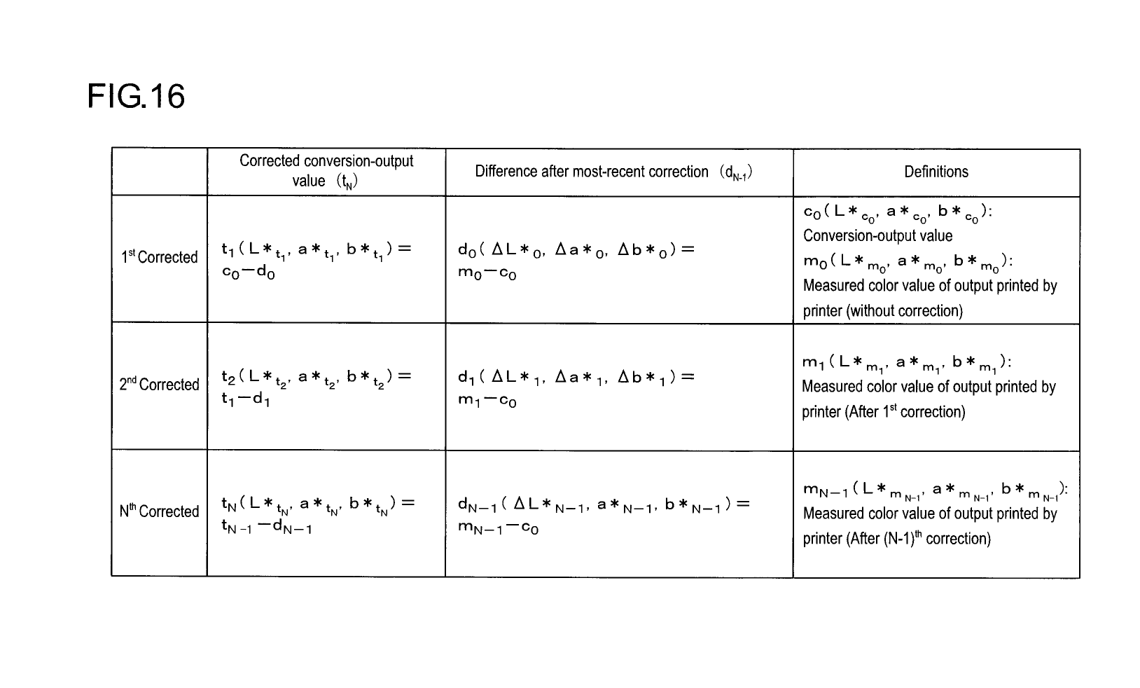

FIG. 16 provides a description of how to calculate the N^{th} corrected conversion-output value which results from N times repetitions of the correction. As shown in the first row in the table in FIG. 16, the 1^{st} corrected conversion-output value (t₁) is calculated by subtracting the difference (d₀) between the measured value of the output by the printer 1 and the conversion-output value (c₀) calculated in S106, from the conversion-output value (c_{O}). This calculation is performed for each L*a*b* element.

The 2^{nd} corrected conversion-output value (t₂) is calculated by subtracting the difference (d₀) between the measured color value (m₁) of the output after the 1^{st} correction and the conversion-output value (c₀), from the 1^{st} corrected conversion-output value (t₁). Similarly, the N^{th} corrected conversion-output value (t_{N}) is calculated by subtracting the difference (d_{N-1}) between the measured value (m_{N-1}) of the output after the (N−1)^{th} conversion and the conversion-output value (c₀), from the (N−1)^{th} corrected conversion-output value (t_{N-1}).

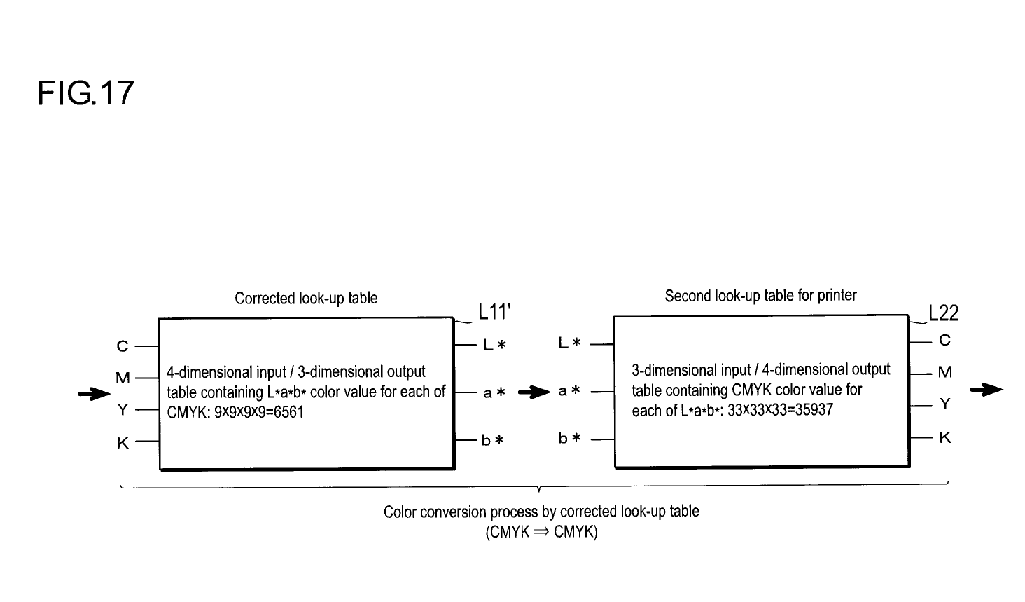

The PC 2 performs the calculation of the corrected conversion-output value for each of the 590 color patches, and then generates the corrected look-up table L11′ storing a corrected CMYK value for each of C×M×Y×K: 9×9×9×9 by means of the interpolation method described in FIG. 8. The PC 2 then performs the color conversion process using a combination of the corrected look-up table L11′ generated in S111 and printer 1's second look-up table L 22, and causes the printer 1 to print out the image data after the color conversion process (S112) before returning to S107. FIG. 17 shows a conceptual diagram of the color conversion process in S112. As shown in FIG. 17, the color conversion process on the image data in S112 uses the corrected look-up table L11′ in S111 instead of the first look-up table L11 shown in FIG. 9.

After that, the PC 2 further executes the steps from S107 to S109 on the image data after the color conversion process by the corrected profiles. The PC 2 further repeats the steps from S111 to S112 and the steps from S107 to S109 until user becomes satisfied with the calculation results of the color differences (ΔE) displayed in S109.

Exemplary calculation results of the mean and maximum values of the color differences (ΔE) after 2 times repetitions of the correction are shown below.

Initially (without correction): 1.5/4.2

After 1st correction: 1.0/4.8

After 2nd correction: 1.1/4.1

These figures suggest that the color differences (ΔE) will generally reduce through repetitions of the profile correction. They also suggest that the color differences (ΔE) of the color patches outside printer 1's color range reduces asymptotically through repetitions of the correction.

As seen from the above, the PC 2 serving as the image processing device in the present embodiment, makes the color adjustment of the printer 1 through the color conversion process using the color profiles P1 and P2, calculates the differences between the L*a*b* measurements of the image data output after the color conversion and the L*a*b* values obtained by converting the image data after the color conversion process using printer 1's first look-up table L11, and evaluates the color adjustment results based on the calculated color differences. Therefore, the present embodiment allows for proper evaluation of the color adjustment results even if there is a mismatch between the reproducible color ranges of the target device and the printer 1, or a difference between the paper types for printing used by the target device and the printer 1.

The invention is not limited to the embodiment described above, and hence it can be modified in various ways within the scope of the appended claims. For example, both the target and object devices in the above embodiment are printing devices, but at least one of them can be any other type of output device such as a display device. If one of them is a display device, the device-dependent color space will typically be RGB color space.

The image processing device according to the invention can be implemented by a dedicated hardware circuit for executing the abovementioned steps, or a program run by a CPU for executing these steps. If the present invention is implemented by the latter, the programs for driving the image processing device can take the form of a computer-readable recording medium such as a Floppy® disk and CD-ROM, or a downloadable file via a network like the Internet. The program stored in the computer readable recording medium is normally transported to a memory device such as a ROM and a hard disk. The program can also take the form of an independent application software, or a built-in function of the image processing device.

What is claimed is:

1. A computer readable recording medium storing a control program of an image processing device capable of making color adjustment of an object device to a target device through a color conversion process which includes converting color values in a device-dependent color space into those in a device-independent color space by means of an input conversion table of the color profile for said target device, and further converting the color values in said device-independent color space after the conversion into color values in said device-dependent color space by means of an output conversion table of the color profile for said object device, wherein said control program causing said image processing device to execute the steps of:
(A) executing said color conversion process on image data containing various color patches;
(B) causing said object device to output said image data after said color conversion process executed in said step (A), and causing a color measuring device to measure the color values in said device-independent color space corresponding to the individual color patches contained in the output of said image data;
(C) calculating color values in said device-independent color space, defined as conversion-output values, by converting the color values in said device-dependent color space corresponding to the individual color patches contained in said image data after said color conversion process executed in said step (A) by means of said input conversion table for said object device; and
(D) calculating the differences between the color values in said device-independent color space measured in said step (B) and the conversion-output values calculated in said step (C).

2. The recording medium as claimed in claim 1, wherein
said program further causes said image processing device to execute the step of (E) displaying information on the differences calculated in said step (D) on a display device.

3. The recording medium as claimed in claim 1, wherein said program further causes said image process device to execute the steps of:
(F) either calculating or causing said color measuring device to measure the color values in said device-independent color space, defined as target values, which correspond to the individual color patches contained in the output of said image data by said target device; and
(G) calculating the differences between the target values calculated in said step (F) and the conversion-output values calculated in said step (C) as well as the differences between the target values calculated in said step (F) and the color values in said device-independent color space measured in said step (B), wherein
in said step (E) information on the differences calculated in said step (G) is displayed, together with, or instead of information on the differences calculated in said step (D).

4. The recording medium as claimed in claim 2, wherein
said information includes at least one of the mean and maximum values of the difference for each of the color patches.

5. The recording medium as claimed in claim 1, wherein
said program further causes said image process device to execute the step of (H) correcting said input conversion table for said target device based on the differences calculated in said step (D).

6. The recording medium as claimed in claim 5, wherein
in said step (H) said input conversion table for said target device is corrected so that the color values in said device-independent color space after the conversion by means of said input conversion table will be replaced by the results of subtracting the differences calculated in said step (D) from the conversion-output values calculated in said step (C).

7. The computer readable recording medium as claimed in claim 5, wherein
said step (H) can be repeated more than one time.

8. The computer readable recording medium as claimed in claim 7, wherein
in the second round of said step (H) onward, said program further causes said image process device to execute the steps of:
(I) causing said object device to output said image data after said color conversion process by means of said input conversion table for said target device after the most recent correction, and causing said color measuring device to measure the color values in said device-independent color space corresponding to the individual color patches contained in the output of said image data by said target device; and
(J) calculating the differences between the color values in said device-independent color space measured in said step (I) and the conversion-output values calculated in said step (C), wherein
said input conversion table for said target device is further corrected so that the color values in said device-independent color space after the color conversion by means of said input conversion table for said target device will be replaced by the results of subtracting the differences calculated in said step (J) from the color values in said device-independent color space after the conversion by means of said input conversion table after the most recent correction.

9. The recording medium as claimed in claim 1, wherein
said device-dependent color space is CMYK color space.

10. The recording medium as claimed in claim 1, wherein
said device-dependent color space is L*a*b* color space.

11. An evaluation method of color adjustment results by an image processing device capable of making the color adjustment of an object device to a target device by means of a color conversion process which includes converting color values in a device-dependent color space into those in a device-independent color space by means of an input conversion table of the color profile for said target device, and further converting said device-independent values after the conversion into other device-dependent color values by means of an output conversion table of the color profile for said object device, comprising the steps of:
(A) executing said color conversion process on image data containing various color patches;
(B) causing said object device to output said image data after said color conversion process executed in said step (A), and causing a color measuring device to measure the color values in said device-independent color space corresponding to the individual color patches contained in the output of said image data;
(C) calculating color values in said device-independent color space, defined as conversion-output values, by converting the color values in said device-dependent color space corresponding to the individual color patches contained in said image data after said color conversion process executed in said step (A) by means of said input conversion table for said object device; and
(D) calculating the differences between the color values in said device-independent color space measured in said step (B) and the conversion-output values calculated in said step (C).

12. The method as claimed in claim 11 further comprises the step of (E) displaying information on the differences calculated in said step (D) on a display device.

13. The method as claimed in claim 12 further comprises the steps of:
(F) either calculating or causing said color measuring device to measure the color values in said device-independent color space, defined as target values, which correspond to the individual color patches contained in the output of said image data by said target device; and
(G) calculating the differences between the target values calculated in said step (F) and the conversion-output values calculated in said step (C) as well as the differences between the target values calculated in said step (F) and the color values in said device-independent color space measured in said step (B), wherein
in said step (E) information on the differences calculated in said step (G) is displayed together with, or instead of information on the differences calculated in said step (D).

14. The method as claimed in claim 12, wherein:
said information includes at least one of the mean and maximum values of the difference for each of the color patches.

15. The method as claimed in claim 11 further comprises the steps of:
(H) correcting said input conversion table for said target device based on the differences calculated in said step (D).

16. The method as claimed in claim 15, wherein
in said step (H) said input conversion table for said target device is corrected so that the color values in said device-independent color space after the conversion by means of said input conversion table will be replaced by the results of subtracting the differences calculated in said step (D) from the conversion-output values calculated in said step (C).

17. The method as claimed in claim 15, wherein
said step (H) can be repeated more than one time.

18. The method as claimed in claim 17, in the second round of the said step (H) onward, further comprising the steps of:
(I) causing said object device to output said image data after said color conversion process by means of said input conversion table for said target device after the most recent correction, and causing said color measuring device to measure the color values in said device-independent color space corresponding to the individual color patches contained in the output of said image data by said target device; and
(J) calculating the differences between the color values in said device-independent color space measured in said step (I) and the conversion-output values calculated in said step (C), wherein
said input conversion table for said target device is further corrected so that the color values in said device-independent color space after the color conversion by means of said input conversion table for the said target device will be replaced by the result of subtracting the differences calculated in said step (J) from the color values in said device-independent color space after the color conversion by means of said input conversion table after the most recent correction.

19. The method as claimed in claim 11, wherein
said device-dependent color space is CMYK color space.

20. The method as claimed in claim 11, wherein
said device-independent color space is L*a*b* color space.
